(19) United States
(12) Patent Application Publication
(10) Pub. No.: US 2016/0048809 A1
(43) Pub. Date: Feb. 18, 2016

(54) FUZZY PLANNING FOR MANAGEMENT OF ACTIVITIES

(71) Applicant: Saied ARBABIAN, Dubai (AE)

(72) Inventor: Saied ARBABIAN, Dubai (AE)

(21) Appl. No.: 14/923,333

(22) Filed: Oct. 26, 2015

Related U.S. Application Data
(63) Continuation of application No. PCT/US2013/038430, filed on Apr. 26, 2013.

(51) Int. Cl. G06Q 10/10; G06N 5/04

(52) U.S. Cl. CPC G06Q 10/1095; G06N 5/048

(57) ABSTRACT

Systems, methods, and non-transitory computer-readable storage media for fuzzy planning for management of activities. The system first receives activities to include in a schedule associated with a user. The system also receives preferences for scheduling the activities, wherein the preferences define time slots in the schedule for the activities, the time slots having varying degrees of preference. Next, the system analyzes the activities and the preferences to match the activities with respective, available time slots selected from the time slots according to the preferences, wherein at least one of the respective, available time slots includes a range of time slots. The system then schedules the activities for the respective, available time slots in the schedule.

### CROSS REFERENCE TO RELATED APPLICATIONS

This application is a continuation of International Application No. PCT/US2013/038430, filed on Apr. 26, 2013, which is expressly incorporated by reference herein in its entirety.

### TECHNICAL FIELD

The present technology pertains to user schedules, and more specifically pertains to fuzzy planning for managing activities in user schedules.

### BACKGROUND

Currently, task management tools only allow the user to define a due date for a task, in order to remind the user of the task at the time of the due date and/or any time before it. Sometimes, task management tools also provide a ‘snooze’ feature, which allows the user to delay a reminder until a future time. These tools can be very helpful in maintaining a list of tasks, particularly when they have a supporting application on a mobile device, such as a smart phone, which allows the user to conveniently access the list of tasks from his or her mobile device at any time. However, these tools typically do not help the user plan his or her schedule.

Some tools go beyond task list management and provide planning features. For example, some calendar applications provide a calendar to allow users to schedule tasks at specific times and durations in advance. Here, the user essentially forecasts future events, and attempts to determine a plan of action for specific times and activities. However, because forecasting rarely is completely accurate, users continuously have to revise their plan of action according to actual events and conditions. Even users that are very disciplined and committed to their plan of action can face unforeseen issues, often caused by external factors out of the user's control, which require the users to revise their plan of action as the unforeseen issues arise. Unfortunately, the continuous need to revise the plan of action can be very tedious and frustrating to the user. Yet, we live in a very dynamic environment, and agility to the changes around us is extremely important, as even a small change, which may seem simple and harmless, can have wide-ranging implications.

Furthermore, the complexities and challenges of planning can significantly increase when one attempts to align the plans of two or more people in order to organize a meeting. Meeting scheduling is a major challenge in the enterprise world, and is the cause of much inefficiency. There are some automatic scheduling systems used in hospitals, manufacturing sites, and airline industries, but their approach is geared towards industries, not individuals, and is very inflexible, leaving very little options and control for the users. Today's business world demands solutions for knowledge workers who need to be very agile to the external and internal circumstances.

Moreover, today's knowledge workers are facing an increasing blend of work and life. Indeed, the typical nine-to-five jobs are diminishing, as work and life blend together. As a result, time management solutions must provide options for a user's work, as well as the user's personal and private life. Further, the new leadership style is more concerned with results than time sheets. Accordingly, today, knowledge workers have increasing pressure to improve efficiency and productivity. However, the current solutions fail to match the increased demand on the knowledge worker. Moreover, the current solutions are not versatile and agile enough for today's dynamic environment.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become fully apparent from the following description and appended claims, or can be learned by the practice of the principles set forth herein.

The approaches set forth herein can be used to manage a user's time, energy, and focus in order to increase the user's productivity. In particular, these approaches can be used to provide a user with a low cost virtual personal assistant, which can be empowered by artificial intelligence. Here, a system can analyze a user's events and tasks and automatically create an ideal plan of action for the user. Moreover, the system can be agile to changes in an individual's agenda and activities, and continuously re-evaluate existing tasks and activities in order to modify the plan of action based on the current circumstances. Thus, the system can provide flexible planning to accommodate today's dynamic environment. This flexibility can be used to avoid scheduling conflicts, maximize time, and increase productivity.

Disclosed are systems, methods, and non-transitory computer-readable storage media for fuzzy planning to manage activities. The system first receives activities to include in a schedule associated with a user. The activities can include events, tasks, assignments, project phases, actions, and so forth. The system can also receive preferences for scheduling the activities. The preferences can define time slots in the schedule for the activities. The time slots can have varying degrees of preference, which can be defined in the preferences. The varying degrees of preference can refer to different priorities, different rankings, different places in an ordering and/or hierarchy, etc. The varying degrees of preference can also refer to varying degrees of importance, interest, choice, suitability, order, relevance, availability, convenience, etc. For example, the preferences can define preferred time slots, alternative time slots, and/or any additional time slots for an activity. This way, the system can determine from the preferences which time slots may be more and less suitable and/or acceptable for each activity. For example, the preferences can define a range of time slots for scheduling an activity. Here, the time slots can include an ideal or preferred time slot for the activity, another time slot representing a second choice for the activity, and any additional time slots, which can represent any additional choices. This can provide the system with multiple options and/or alternatives for scheduling the activity. In some cases, the time slots included in the range of time slots can be ranked and/or ordered. Moreover, the number of time slots defined in the preferences for the activities can vary by activity. For example, the preferences can define multiple time slots for some activities, but only a single time slot for other activities. In other words, the preferences can provide the system with multiple options for scheduling some activities, and only one option for scheduling other activities. For example, some activities may have to be scheduled at a particular time for reasons that may be out of the user's control. Here, the preferences may only specify one option (e.g., the particular time) for scheduling these activities. On the other hand, some activities are more flexible, and may be scheduled at various times. Thus, the preferences can specify various options for scheduling such activities.

The preferences can also define priorities for the activities, relationships between the activities, durations for the activities, dependencies between the activities, deadlines for the activities, requirements, prerequisites, etc. For example, the preferences can specify that some activities have a high priority while other activities have a low priority. In some cases, the preferences can include more than one deadline for one or more activities. For example, the preferences can define a soft deadline and a hard deadline for an activity. The soft deadline can indicate that the activity should be completed by the soft deadline, but may be completed at a later time if necessary. The hard deadline can indicate that the activity must be completed by the hard deadline, and the time allotted for the activity cannot be extended. The preferences can also include a deadline spectrum, which can be fuzzy and can range anywhere between hard and soft.

Next, the system can analyze the activities and the preferences to match the activities with respective, available time slots selected from the time slots according to the preferences. The time slots needed to fulfill an activity can be matched and assigned to a pool of time slots for the activity with varying degrees of preference. The system can match the time slots needed for the activity to the most preferred and available time slots from the pool, for example. The pool of time slots with varying degrees of preference enables flexibility in scheduling to accommodate changes in the activities and/or potential conflicts. For example, an activity can be matched with a pool of time slots, so the activity can be scheduled for any of the time slots in the pool of time slots. Thus, if the activity is scheduled for a time slot in the pool of time slots, and the system subsequently determines that the activity has to be scheduled for a different time slot, the system can then reschedule the activity for any other time slot from the pool of time slots. Here, the system can select an appropriate time slot from multiple time slots for scheduling the activity and avoiding, minimizing, and/or managing any conflicts.

The system can then schedule activities for the respective, available time slots in the schedule. For each activity, the system can avoid, minimize, prioritize, and/or manage a conflict with other activities by scheduling the activity for the respective, available time slot, as the respective, available time slot was selected by the system for that purpose from the time slots defined in the preferences. Moreover, the scheduling process can be flexible, allowing the system to choose a time slot for each activity from a number of different time slots that are available so that system can accommodate each activity without a conflict. The system can also dynamically and automatically reschedule any of the activities to accommodate new activities and/or any change in circumstances. For example, the system can schedule activity A for 9:00 a.m.-10:00 a.m., and activity B for 10:00 a.m.-11:30 a.m. If activity A runs 30 minutes late, and does not end until 10:30 a.m., the system can dynamically and automatically reschedule activity B and/or any other future activities in the schedule that are affected by the fact that activity A ran 30 minutes late. Here, the system can reschedule activity B to 10:30 a.m.-12:00 p.m., for example. This way, the system can avoid any conflicts with activity A that may arise when activity A runs late. The system can also determine if any activities scheduled after activity B would be affected by the rescheduling of activity B. If so, the system can reschedule the affected activities in a similar way as the rescheduling of activity B.

The new time slot added to activity B, viz., 11:30 a.m.-12:00 p.m., can be selected by the system from the time slots defined by the preferences for activity B. For instance, if the preferences specify that the preferred time slot for activity B is 10:00 a.m.-11:30 a.m., and any additional time slots for activity B can include 9:30 a.m.-10:00 a.m. and 11:30 a.m.-1:00 p.m., then the system can automatically reschedule activity B for any of the time slots defined for activity B. The time slots defined in the preferences can provide the system with a range of time slots for activity B from 9:30 a.m.-1:00 p.m., as necessary to avoid, minimize, prioritize, and/or manage a conflict and/or accommodate a change in circumstances. In our example, the system rescheduled activity B to start at 10:30 a.m., which is defined by the preferences as one of the preferred time slots for activity B, and end at 12:00 p.m., which is defined by the preferences as one of the additional time slots for activity B. Thus, the system combined some of the preferred time slots for activity B with some of the additional time slots for activity B in order to accommodate a change of circumstances (i.e., activity A running 30 minutes late).

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary cloud computing system configuration;

FIG. 2 illustrates an example fuzzy planning system;

FIG. 3 illustrates an example fuzzy template for a work week;

FIG. 4 illustrates an example fuzzy deadline for an activity;

FIG. 5 illustrates an example system for sending an update to a fuzzy planning system;

FIG. 6 illustrates an example warning for extending an activity;

FIG. 7 illustrates a first example method embodiment;

FIG. 8 illustrates a second example method embodiment; and

FIGS. 9A and 9B illustrate example system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

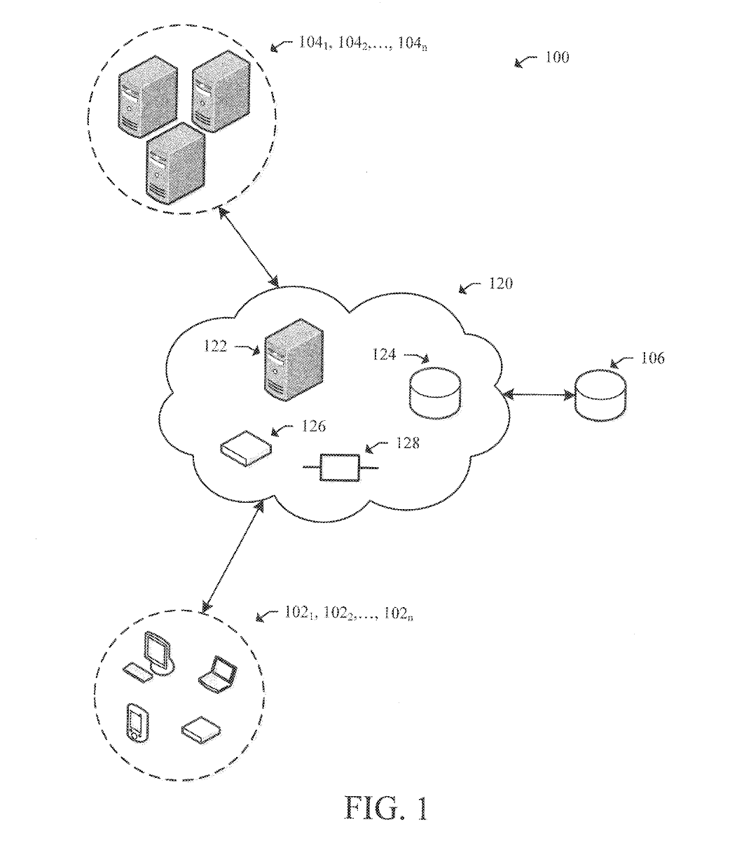

The disclosed technology addresses the need in the art for flexible and efficient technologies for managing activities. Disclosed are systems, methods, and non-transitory computer-readable storage media for fuzzy planning to manage activities. A brief introductory description of an exemplary cloud computing system configuration is disclosed herein. A discussion of fuzzy planning and a more detailed description of fuzzy planning for management of activities will then follow. These variations shall be described herein as the various embodiments are set forth. The disclosure now turns to FIG. 1.

Cloud computing is a type of Internet-based computing in which a variety of resources are hosted and/or controlled by an entity and made available by the entity to authorized users via the Internet. An exemplary cloud computing system configuration 100 is illustrated in FIG. 1, wherein a variety of electronic devices can communicate via a network for purposes of exchanging content and other data. The system can be configured for use on a wide variety of network configurations that facilitate the intercommunication of electronic devices. For example, each of the components of system 100 in FIG. 1 can be implemented in a localized or distributed fashion in a network.

System 100 can be configured to include cloud computing resources 120. The cloud resources can include a variety of hardware and/or software resources, such as cloud servers 122, cloud databases 124, cloud storage 126, cloud networks 128, cloud applications, cloud platforms, and/or any other cloud-based resources. In some cases, the cloud resources are distributed. For example, cloud storage 126 can include multiple storage devices. In some cases, cloud resources can be distributed across multiple cloud computing systems and/or individual network enabled computing devices. For example, cloud computing resources 120 can communicate with servers 104₁, 104₂, . . . , 104ₙ (collectively “104”), database 106, and/or any other network enabled computing device to provide the cloud resources.

Furthermore, in some cases, the cloud resources can be redundant. For example, if cloud computing resources 120 is configured to provide data backup services, multiple copies of the data can be stored such that if one storage resource is unavailable the data will still be available to the user. In another example, if cloud computing resources 120 is configured to provide software, the software can be available from different cloud servers so that the software can be served from the closest server.

In system 100, a user interacts with the cloud computing resources 120 through user terminals 102₁, 102₂, . . . , 102ₙ (collectively “102”) connected to a network by direct and/or indirect communication. Cloud computing resources 120 can support connections from a variety of different electronic devices, such as servers; desktop computers; mobile computers; handheld communications devices, e.g., mobile phones, smart phones, tablets; set top boxes; network-enabled hard drives; and/or any other network-enabled computing devices. Furthermore, cloud computing resources 120 can concurrently accept connections from and interact with multiple electronic devices.

Cloud computing resources 120 can provide cloud resources through a variety of deployment models, such as public, private, community, hybrid, and/or any other cloud deployment model. In some cases, cloud computing resources 120 can support multiple deployment models. For example, cloud computing resources 120 can provide one set of resources through a public deployment model and another set of resources through a private deployment model.

In some configurations, a user terminal 102ᵢ can access cloud computing resources 120 from any location where an Internet location is available. However, in other cases, cloud computing resources 120 can be configured to restrict access to certain resources such that a resource can only be accessed from certain locations. For example, if cloud computing resources 120 is configured to provide a resource using a private deployment model, then cloud computing resources 120 can restrict access to the resource, such as by requiring that a user terminal 102ᵢ access the resource from behind a firewall.

Cloud computing resources 120 can provide cloud resources to user terminals 102 through a variety of service models, such as Software as a Service (SaaS), Platforms as a service (PaaS), Infrastructure as a Service (IaaS), and/or any other cloud service models. In some cases, cloud computing resources 120 can provide multiple service models to a user terminal 102ᵢ. For example, cloud computing resources 120 can provide both SaaS and IaaS to a user terminal 102ᵢ. In some cases, cloud computing resources 120 can provide different service models to different user terminals 102. For example, cloud computing resources 120 can provide SaaS to user terminal 102₁ and PaaS to user terminal 102₂.

In some cases, cloud computing resources 120 can maintain an account database. The account database can store profile information for registered users. The profile information can include resource access rights, such as software the user is permitted to user, maximum storage space, etc. The profile information can also include usage information, such as computing resources consumed, data storage location, security settings, personal configuration settings, scheduling information and/or preferences, etc.

Cloud computing resources 120 can provide a variety of functionality that requires user interaction. Accordingly, a user interface (UI) can be provided for communicating with cloud computing resources 120 and/or performing tasks associated with the cloud resources. The UI can be accessed via an end user terminal 102ᵢ in communication with cloud computing resources 120. The UI can be configured to operate in a variety of client modes, including a fat client mode, a thin client mode, or a hybrid client mode, depending on the storage and processing capabilities of cloud computing resources 120 and/or the user terminal 102ᵢ. Therefore, a UI can be implemented as a standalone application operating at the user terminal in some embodiments. In other embodiments, a web browser-based portal can be used to provide the UI. Any other configuration to access cloud computing resources 120 can also be used in the various embodiments.

Cloud computing resources 120 can provide and also maintain a calendar, a schedule, activities, etc., for a user terminal 102ᵢ. Moreover, cloud computing resources 120 can manage the calendar, the schedule, the activities, etc., for the user terminal 102ᵢ. For example, the cloud computing resources 120 can provide a plan of action to the user terminal 102ᵢ, based on activities associated with a user at the terminal 102ᵢ. The cloud computing resources 120 can maintain and manage the plan of action, and continuously reschedule activities in the plan of action as needed to accommodate new activities or a change in circumstances, for example. The cloud computing resources 120 can also maintain a list of activities and preferences associated with a user at the terminal 102ᵢ. The cloud computing resources 120 can maintain the list of activities and/or preferences at the database 106, for example. In some cases, the cloud computing resources 120 can provide fuzzy planning for management of activities, as further described below.

As described above, in some configurations, the cloud computing resources can be used to store user data. The present disclosure contemplates that, in some instances, this gathered data might include personal and/or sensitive data. The present disclosure further contemplates that the entities responsible for the collection, analysis, disclosure, transfer, storage, or other use of such data should implement and consistently use privacy policies and practices that are generally recognized meeting or exceeding industry or governmental requirements for maintaining personal information data private and secure. For example, personal data from users should be collected for legitimate and reasonable uses of the entity and not shared or sold outside of those legitimate uses. Further, such collection should occur only after the informed consent of the users. Additionally, such entities should take any needed steps for safeguarding and securing access to such personal data and ensuring that others with access to the personal data adhere to their privacy and security policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal data. That is, the present disclosure contemplates that hardware and/or software elements can be provided to prevent or block access to such personal data. For example, the present technology can be configured to allow users to select the data that is stored in cloud storage.

Therefore, although the present disclosure broadly covers use of personal data to implement one or more various disclosed embodiments, the present disclosure also contemplates that the various embodiments can also be implemented without the need for accessing such personal data. That is, the various embodiments of the present technology are not rendered inoperable due to the lack of all or a portion of such personal data. For example, non-personal data can be stored in cloud storage.

The disclosure now turns to a discussion of fuzzy planning. A fuzzy planning system can provide a user with a low cost virtual personal assistant empowered by artificial intelligence. This service can be provided in the cloud, to allow the user to access the fuzzy planning system from different devices. The fuzzy planning system can receive and analyze the activities that an individual needs to attend, and make an optimum plan of action for the user. The fuzzy planning system is agile to changes in an individual's agenda and activities, and continuously re-evaluates the activities to make any changes necessary for an optimum plan.

The fuzzy planning concept can be based on the fact that all plans are based on forecasts of events, and forecasts are rarely 100% accurate. For example, one plans to be at work by 9:00 A.M., and assumes a 50 minute commute time. The reality is that the commute time is never exactly 50 minutes, and in fact, the commute can typically range from about 45 minutes to several hours, depending on the road conditions. Using a fuzzy plan, the same individual can plan to be at work in the morning, preferably by 9:00 A.M. This can be very different from planning a sharp start at 9:00 A.M. If the individual plans a sharp start at 9:00 A.M., and the circumstances prevent the individual from being at work by 9:00 A.M., the individual's tardiness would create a score of problems with the individual's schedule. On the other hand, the fuzzy planning system would fare much better. The fuzzy planning system can be aware of everything that the individual needs to accomplish during a day, week, month, or even year, and can help the individual manage her time to accomplish everything that the individual needs to accomplish, while avoiding adverse effects as much as possible.

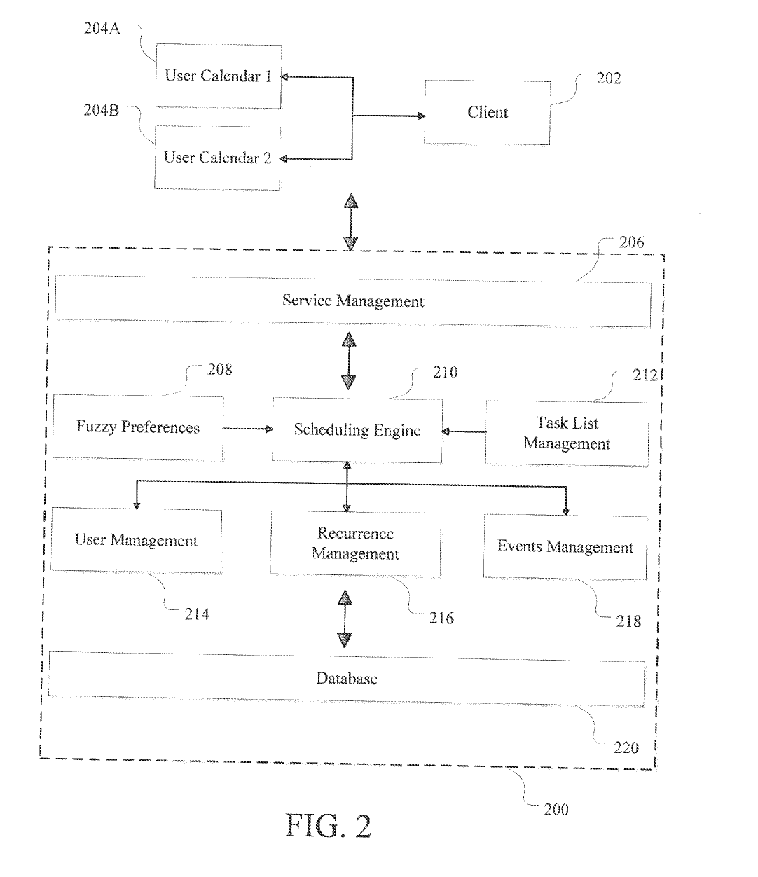

The disclosure now turns to FIG. 2, which illustrates an example fuzzy planning system 200. Here, the fuzzy planning system 200 can be implemented using the components of the cloud computing system 100 of FIG. 1. Alternatively, any of the components of the fuzzy planning system 200 can be separate from the cloud computing system 100 of FIG. 1. Moreover, while the concepts disclosed herein are discussed in terms of a cloud computing environment, the present disclosure contemplates extending these concepts to other environments, such as a personal computing environment or a distributed computing environment, for example.

The fuzzy planning system 200 can generate and maintain calendars 204A-B for the client 202. The client 202 can be any device with networking capabilities, such as user terminal 102ᵢ, as illustrated in FIG. 1. The calendars 204A-B can be based on a flexible plan of action generated by the fuzzy planning system 200. The fuzzy planning system 200 can include service management component 206, fuzzy preferences 208, scheduling engine 210, task list management 212, user management 214, recurrence management 216, events management 218, and database 220. In some embodiments, the fuzzy planning system 200 can be based on a service oriented architecture (SOA), where the above components are hosted in the cloud and are available as a service to the devices outside the cloud. Here, the client devices can call the services to provide user inputs and get responses on scheduled tasks and events.

The present disclosure now turns to a description of each of the components 208-220 of the fuzzy planning system 200. The service management component 206 can manage the services and functionality of the fuzzy planning system 200. The service management component 206 can also provide calendars 204A-B, generated by the fuzzy planning system 200, to the client 202. This way, the client 202 can access the calendars 204A-B at any time, directly from the cloud. Moreover, the client 202 can communicate information to the service management component 206 for creating and/or updating the calendars 204A-B. The service management component 206 can then communicate the information from the client 202 to the components 208-220 of the fuzzy planning system 200.

Scheduling engine 210 can use inputs from components 208 and 212-220 to automatically build the schedules 204A-B based on an optimum plan of action. The scheduling engine 210 can search through time in the future, and identify the best time slots that fit into an activity's criteria. Moreover, when two or more people need to align their plans or schedules, the scheduling engine 210 can make a two-dimensional (time and people) search to find the best time slots to align the user's schedules or plans based on the optimum plan of action.

Fuzzy preferences 208 can represent the flexibility of people in what they intend to accomplish. This flexibility can refer to times when an individual can work on something, when the individual has to deliver the work, etc. Fuzzy preferences 208 can include fuzzy templates and fuzzy deadlines for specifying the flexibility of people. The fuzzy templates and fuzzy deadlines are further described below.

With the fuzzy planning system 200, the individual does not have to decide when to schedule a particular activity, as the scheduling engine 210 does this automatically for the individual. The individual simply needs to provide key requirements and information, such as when an activity needs to be completed, or the relative priority of the activity. This information allows the scheduling engine 210 to provide flexibility in the planning process. This can be a great benefit to the individual. For example, as the number of tasks in an individual's schedule increases, it becomes generally more difficult for the individual to meet the due dates of all the tasks. Therefore, a certain degree of flexibility can be provided on behalf of the individual, to help the fuzzy planning system 200 make the optimal plan of action for the individual. At times, the individual may have to make compromises on completion times of lower priority tasks, or the hours of the day or week the user is willing to be work on the tasks. However, the individual can specify her preferred options and any compromises she is willing to make, to allow the fuzzy planning system 200 to automatically manage the individual's schedule. In other words, the individual can define how flexible she is during the week, in terms of the hours of work per day or how flexible she is with due dates to complete the tasks. The individual can define her flexibility via fuzzy preferences 208.

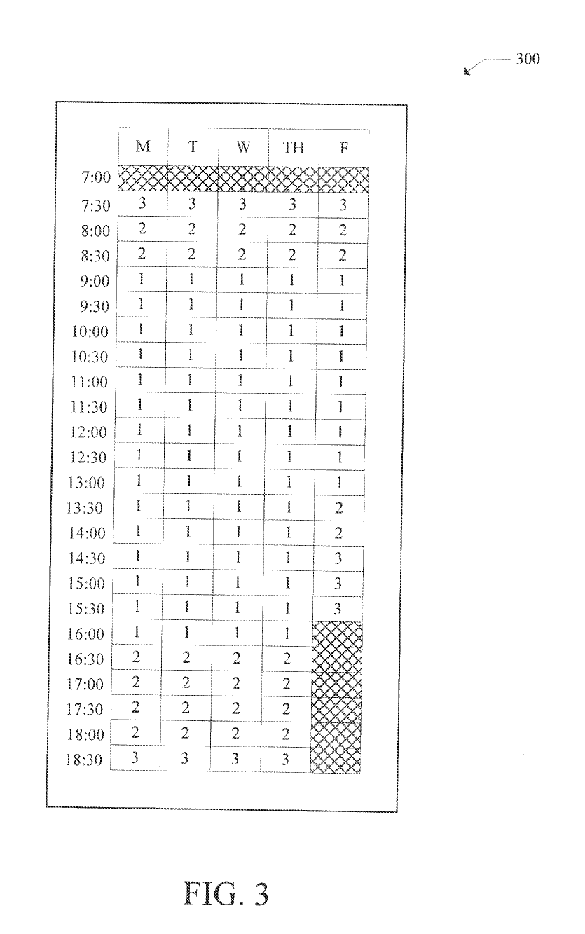

Fuzzy preferences 208 can represent the flexibility of people in what they intend to accomplish. This flexibility can refer to times when an individual can work on something, when the individual has to deliver the work, etc. Fuzzy preferences 208 can include fuzzy templates and fuzzy deadlines for specifying the flexibility of people. A fuzzy template can be a template that contains the user preferences for each hour of the day and each day of the week for doing a certain activity. For example, John would like to work on his work related tasks between 9:00 A.M. to 5:00 P.M., but is willing to stay late, or start early if required. He is not willing, however, to start any earlier than 7:30 A.M., or leave his work any later than 7:00 P.M. John also prefers to get his key tasks done earlier in the day, rather than late in the afternoon. He usually wraps-up his week by Friday at lunch time, but is willing to stay back if required; although he is not willing to stay later than 4 P.M. The fuzzy templates allow John to communicate his preferences to the scheduling engine 210, in order for the scheduling engine 210 to avoid any undesired hours, unless the adverse effects of missing deadlines are worse than the effects of working during the undesired hours. FIG. 3 further illustrates this example.

The individual can have multiple fuzzy templates for different types of activities. For example, an individual might want to define a fuzzy template for her lunch in order to plan a 30 minute daily lunch break. This fuzzy template can enable the individual's lunch schedule to be flexible. For example, the fuzzy template can specify that lunch can be scheduled any time between 12:00 P.M. to 2:00 P.M. This can offer realistic planning, as unforeseen events require flexibility. Another example is a fuzzy template specifying a preference for a weekend brunch to be scheduled on Sunday at 11:00 A.M., but also specifying that the brunch can also be scheduled later. In fact, the fuzzy templates can specify that if Sunday does not work, Saturday can be the second preference for scheduling the brunch. Thus, the fuzzy templates can include various options in terms of days, hours, and even weeks for scheduling an activity.

The timeline of a task can be important in determining when the task can start and when it must be completed. The start time of a task can depend on any temporal relations that the task has with other events. For example, if a task has a pre-requisite event or task, it cannot start until the prerequisite, dependent event or task is completed. Moreover, some tasks have a very hard deadline, such as submission of tax forms, and others have softer, self-inflicted deadlines, which can be used in order to increase productivity. In either case, usually, the sooner the task is completed the better. In other words, leaving the completion of the tasks to the last minute can be risky, as unexpected events can potentially interrupt the task.

In order to enable the automatic scheduling of tasks, fuzzy deadlines can be included in the fuzzy preferences 208. The fuzzy deadlines can include a range of deadlines for an activity. For example, the fuzzy deadlines can be used to indicate three deadlines for a task. First, the green deadline can be used to indicate that it is preferable to complete the task by the time of the green deadline, but perhaps not mandatory. Second, the yellow deadline can be used to indicate that the task should be completed by the time of the yellow deadline, but there is still some grace period which will end by the red deadline. Finally, the red deadline indicates the mandatory deadline. For example, a user needs to complete a task that is estimated to take 20 hours before the 5th of April. The user would like to finish this task by March 29th, but the hard deadline is the 9^{th} of April. This information can be communicated to the fuzzy planning system 200 via fuzzy deadlines in the fuzzy preferences 208. Thus, the fuzzy deadlines can include a deadline spectrum, which can be fuzzy and can range anywhere between hard and soft, for example. In the absence of a fuzzy deadline, the fuzzy planning system 200 does not differentiate early completion of the task versus late completion of the task, as long as the task is completed before the single hard deadline.

Since the user delegates planning to the fuzzy planning system 200, the process can be transparent to the user. However, the user can be informed if his task is being pushed back to the yellow or red deadlines due to workload constraints. To continue on the above example, let's assume that the fuzzy planning system 200 comfortably finds time to schedule 20 hours for the task before March 29th. Later in the week, various un-planned, but high-priority tasks with urgent timelines are introduced. The fuzzy deadlines enable the fuzzy planning system 200 to realize that the task can be postponed to the following week in order to accommodate the new, high priority tasks. The fuzzy deadlines also enable the fuzzy planning system 200 to provide the right warnings to the user when his task falls in the yellow or red deadlines.

Task List Management 212 can be a storage of tasks that an individual would like to do. For example, task list management 212 can be a database containing the individual's tasks that need to be scheduled. The tasks in the task list management 212 can be associated with various attributes, such as priority, fuzzy templates, fuzzy deadlines, etc.

Events Management 218 can be a storage of events that an individual would like to participate in. Like the task list management 212, the events management 218 can be a database of events associated with an individual. Moreover, the events in the events management 218 can also be associated with various attributes, such as priority, fuzzy templates, fuzzy deadlines, etc.

User Management 214 can be a standard user authentication and authorization module for managing access to the fuzzy planning system 200 by users. The database 220 can be a standard relational database management system (RDMS) repository to capture various data elements throughout the fuzzy planning system 200.

Recurrence management 216 can implement the fuzzy planning concept to recurring tasks and/or events. One of the challenges with existing manual scheduling tools, such as calendar applications, is that it is very hard to fix recurring events with no time conflict, for any of the occurrences of the series of recurring events. Typically, a user has to specify the exact time or day of week of the event that the user wishes to correct; however, the manual scheduling tools generally fix exactly the same time for all occurrences, rather than fixing a single instance of the series of recurring events. Consequently, the user then has to manually move the occurrences where there is a time conflict. This can be a tedious task. By contrast, with the fuzzy planning system 200, the user can specify a degree of flexibility in the timing of the events. As an example, a user wants to schedule a recurring weekly staff meeting towards the end of each week. With the recurrence management 216, the user can specify that her preference is Friday mornings, but Thursday mornings will also be good for weeks in which Friday mornings do not work. Moreover, she can also specify that she would like to avoid afternoons as much as possible, but if all else fails, afternoons are also acceptable. Here, with the fuzzy template, the time of the weekly meeting can be flexible, and even float around the end of the week. The exact timing of the meeting can depend on the other events and their priorities and timelines. The fuzzy planning system 200 can exploit this floating space in order to accommodate a solution for all tasks and events.

Let's say the first occurrence of the weekly staff meeting is the week commencing May 26th. The fuzzy planning system can identify that a task must be completed first in the morning of Friday, May 31, according to its deadline. Nevertheless, there is still enough space to schedule the weekly staff meeting in a preferred green deadline; i.e., Friday morning. The following week (week commencing June 2nd), Friday is already blocked for the user due to a factory site visit. The fuzzy planning system can automatically schedule the weekly staff meeting on Thursday morning, as the next preferred alternative according to the fuzzy template. Later, say on the 5th of June, late afternoon, an urgent task comes up for the user. Here, the user has to submit RX forms before tomorrow (Thursday) 12:30 PM. The fuzzy planning system can automatically shift the weekly staff meeting to the one of the least favored times, i.e., Thursday afternoon. Although this timing is not preferred, it is still within the acceptable range of time.

The above examples only show the availabilities and flexibilities of a single user. However, in some cases, such as weekly meetings, the scheduling can involve availabilities and flexibilities of multiple users. The fuzzy planning system 200 can align the plans of multiple users together.

In today's typical business environment, the meeting scheduling can be a daunting task, especially if the number of participants increases, or if the meeting is urgent and cannot wait for long. This is because each individual usually has existing plans and blocked times that need to be considered. However, in a business environment where all employees are using the fuzzy planning system 200, all tasks and events can be associated with a fuzzy template, which allows each event in a user's calendar to be flexible to reschedule for different times. This flexibility can create a space of search for the fuzzy planning system to investigate how to move all individual events or tasks in everyone's calendar around in order to accommodate a new task or meeting. The search can use a convolution of fuzzy templates to find the optimal solution, where the least amount of adverse effect is achieved. The adverse effects can include working in undesired hours for some individuals, or conducting a meeting or task during the yellow or red deadlines.

The same concept can be applied in the social space. Once ‘friends’ start planning their days using the fuzzy planning system 200, getting together becomes a lot easier. A user simply needs to indicate a desire to get together with specific friends, say sometime in the next two weeks, preferably evenings. The friends can then get notified of the user's intent to meet. The friends can then supply their fuzzy preferences 208, including their fuzzy templates and fuzzy deadlines. The fuzzy planning system 200 can then find the best time for all users to meet, and automatically schedule the meeting for the users. Conveniently, if someone is late or held-up before the planned time, the fuzzy planning system 200 can seamlessly reschedule the meeting. With the fuzzy planning system 200, users do not have to firm-up any plans, unless doing so is required for reasons associated with temporal dependencies. If a meeting or task is moved, the user can rest assure that all requirements are under control.

Moreover, the fuzzy planning system 200 can blend multiple personal and business calendars. For example, John is a busy executive who is using the fuzzy planning system 200 for his work and personal life. His wife, Kate also uses the fuzzy planning system 200. John wants to make a dinner date with Kate, and uses the fuzzy planning system 200 to organize the date. His preference is towards the end of the week, sometime after 6:00 P.M. He also prefers to leave by 8:30 P.M., or at the latest, by 9:00 P.M. He defines these criteria in a fuzzy template in the fuzzy preferences 208. Kate then gets notified of John's invitation, and also sets her fuzzy template. She is actually more flexible and available any time after 5:00 P.M. from Wednesday to Friday. The fuzzy planning system 200 then searches the convoluted time spaces of both individuals, and finds the best time—as of now—for the couple to meet. The fuzzy planning system 200 can communicate the tentative date of Thursday at 6:30 PM. Both individuals know the date is tentative and can be changed. All events can float around the schedules to accommodate the circumstances, while trying best to keep everyone happy. Also, no one has time conflicts with other tasks or events in their calendars. Moreover, there is no need for phone calls or apologies to reschedule a meeting, as the fuzzy planning system 200 takes care of all communications, scheduling, and agreements.

To expand on the previous example, assume that John starts his day on Thursday and everything goes according to the plan until mid-day. At 1:30 P.M., John realizes that his conference is going to overrun by 30 minutes. He then immediately updates the fuzzy planning system 200 of the circumstances. The fuzzy planning system 200 searches the time space to assess the impact. Here, the fuzzy planning system 200 can determine if the 30 minute delay is going to require other meetings to be rescheduled. The fuzzy planning system 200 can also determine if the 30 minute delay is going to have an adverse effect on the user's ability to complete any of the scheduled tasks. For example, the fuzzy planning system 200 can determine if the 30 minute delay is going to require the user to work in early or late hours of the day, or complete the task in yellow or red deadlines. All repercussion of this delay can be communicated to all affected individuals. In the above example, the fuzzy planning system 200 can notice the fuzzy deadline for completing a particular task has no more grace period to postpone, and must be completed today. Therefore, the fuzzy planning system 200 extends the task's planned time to 6:30 P.M., to compensate for the 30 minute delay by the conference call. John, however, had indicated in his fuzzy template that he really did not prefer to stay in the office later than 6:00 P.M. Therefore, the fuzzy planning system 200 warns John of the consequences of the extension of the conference call: that he will need to work late.

In the meantime, Kate can get notified of the delays in John's schedule, and can receive a refreshed tentative timing of the dinner date. Later in the afternoon, at around 4:30 P.M., John realizes that he needs to spend more time than planned on the particular task, so he notifies the fuzzy planning system 200. The fuzzy planning system 200 can then take care of notifying Kate and rescheduling the date to 7:30 P.M. At 7:30 PM, the couple can finally meet on their date, one hour later than the initial tentative plan.

While the fuzzy planning concepts are described above with respect to scheduling activities for a user, the present disclosure contemplates that the fuzzy planning concepts described above can be implemented for scheduling other things, such as resources. For example, the fuzzy planning concepts can be used to schedule one or more resources for use during specific time slots. As another example, the fuzzy planning concepts can be used to schedule a resource to different users at specific time slots, in order to distribute the workload and/or the use of the resource among various users. In some cases, the fuzzy planning system 200 can also be integrated and/or linked with other scheduling systems. For example, the fuzzy planning system 200 can be integrated with a separate calendaring system in order to automatically schedule activities in the separate calendaring system. Moreover, the separate calendaring system can be associated with a resource or location. For example, the separate calendaring system can be a reservation system for one or more restaurants. In some cases, the fuzzy planning system 200 can communicate with online systems, such as online reservation or appointment systems in order to automatically submit a request to schedule and/or reserve a time and/or resource with the online system. For example, the fuzzy planning system 200 can schedule a dinner at Joe's Pizza Shop between Mary and Lisa for next Friday at 8:00 P.M. The fuzzy planning system 200 can then automatically communicate with Joe's Pizza Shop's reservation system to make a reservation at Joe's Pizza Shop for next Friday at 8:00 P.M. Alternatively, the fuzzy planning system 200 can also make the reservation at Joe's Pizza Shop via any other system, such as a registering system for a network of restaurants, like OPENTABLE by OPENTABLE EUROPE Limited from 5 New Street Square, London EC4A 3TW.

The fuzzy planning system 200 can also gather data from other systems to integrate in the fuzzy planning process. For example, the fuzzy planning system 200 can gather travel data from the Internet, such as mapping information, to determine driving time and traffic data to identify possible travel delays. As another example, the fuzzy planning system 200 can link to a train or airplane schedule and/or status, to ensure that transportation will be available before or after a scheduled activity. The fuzzy planning system 200 can send a notification and/or warning to the user based on the data gathered. For example, the fuzzy planning system 200 can notify the user that a train is delayed. In some cases, the fuzzy planning system 200 can also automatically adjust the schedule based on the data gathered. For example, if the user is scheduled to take an airplane at 4:00 P.M., the fuzzy planning system 200 can link to the airline's website before the schedule trip to check the status of the airplane. If the data gathered from the airline's website indicates that the scheduled flight is delayed by 30 minutes, the fuzzy planning system 200 can extend the scheduled trip by 30 minutes to accommodate for the delay.

FIG. 3 illustrates an example fuzzy template 300 for a work week. The fuzzy template 300 contains user preferences for each hour of the day and each day of a work week for performing work-related activities. The fuzzy template 300 can define time slots having varying degrees of preference. Here, the time slots marked with a 1 indicate that those time slots are the preferred time slots for performing the work-related activities. The time slots marked with a 2 indicate that those time slots are the next preferred time slots for performing the work-related activities. Finally, the time slots marked with a 3 indicate that those time slots are the least preferred time slots for performing the work-related activities. In other words, the time slots marked with a 1 are ranked first, the time slots marked with a 2 are ranked second, and the time slots marked with a 3 are ranked third, with respect to available time slots for performing the work-related activities. Moreover, the time slots without a number marking indicate that those time slots are not an option for scheduling a time to perform the work-related activities.

As illustrated in FIG. 3, the fuzzy template 300 indicates that the user's preferred times for performing the work-related activities are Monday through Thursday from 9:00 A.M. until 4:30 P.M., and Friday from 9:00 A.M. until 1:30 P.M. The fuzzy template 300 also indicates that the user's next preferred times for performing work-related activities are Monday through Thursday from 8:00 A.M. until 9:00 A.M., and from 4:30 A.M. until 6:00 P.M.; and Friday from 8:00 A.M. until 9:00 A.M., and from 1:30 P.M. until 2:30 P.M. Finally, the fuzzy template 300 indicates that the user's least preferred times for performing the work-related activities are Monday through Friday starting at 7:30 A.M, Monday through Thursday until 6:30 P.M., and Friday until 3:30 P.M. The fuzzy template 300 also indicates that the user will not perform any work-related activities before 7:30 A.M or Fridays after 4:00 P.M.

As noted above, the fuzzy template 300 indicates the different times and preferences of the user for performing the work-related activities. Based on the information from the fuzzy template 300, the fuzzy planning system 200 can automatically schedule the different work-related activities for the user and automatically reschedule any activities as needed to accommodate a new activity, a conflict, a change of circumstances, etc. The fuzzy planning system 200 can first try to schedule activities for the preferred time slots, which are marked with a 1 in the fuzzy template 300. However, the fuzzy planning system 200 can schedule a work-related activity for any of the times marked with a 2 or 3, if the fuzzy planning system 200 determines that doing so is necessary to accommodate a new activity, a conflict, a change in circumstances, etc. For example, if the fuzzy planning system 200 determines that the user must work additional hours to avoid missing an important deadline for an activity, it can schedule the additional hours for the activity from the time slots marked with a 2 and/or 3 in the fuzzy template 300, to avoid missing the deadline.

The fuzzy template 300 can also indicate scheduling preferences for a recurring activity. Here, the fuzzy template 300 can indicate a range of time slots for a recurring activity. The time slots included in the range of time slots can be ranked and/or prioritized. The fuzzy planning system 200 can then use the fuzzy template 300 to reschedule an occurrence in a series of recurring activities, in order to accommodate a new activity, a conflict, and/or a change in circumstances. For example, the fuzzy planning system 200 can schedule a recurring activity for Wednesdays at 3:00 P.M. The fuzzy template 300 can indicate that the preferred time for the recurring activity is every Wednesday at 3:00 P.M. The fuzzy template 300 can also indicate a next preferred time slot of 3:30 P.M. on Wednesdays for the recurring activity, and a least preferred time slot of 4:00 P.M. on Thursdays for the recurring activity. Thus, if the fuzzy planning system 200 identifies a conflict on Wednesday this week with the 3:00 P.M. time slot, the fuzzy planning system 200 can try to reschedule this week's instance of the recurring activity to the next preferred time slot, which is Wednesday at 3:30 P.M. If no conflict exists with the next preferred time slot, then the fuzzy planning system 200 can reschedule this week's instance of the recurring activity to the next preferred time slot, on Wednesday at 3:30 P.M. On the other hand, if the fuzzy planning system 200 determines that the next preferred time slot (i.e., Wednesday at 3:30 P.M.) cannot be used to reschedule this week's instance of the recurring activity (e.g., there is a conflict with another activity), then the fuzzy planning system 200 can try to reschedule this week's instance of the recurring activity to the least preferred time slot, on Thursday at 4:00 P.M. This way, the fuzzy template 300 can provide some flexibility to the fuzzy planning system 200 for scheduling and/or rescheduling any particular instance of the recurring activity.

While the fuzzy template 300 is illustrated in FIG. 3 with number markings to specify the user's preferences and/or ranking of time slots, the present disclosure contemplates that other methods can be used to indicate the user's preferences or rankings. For example, the fuzzy template 300 can be color coded, such that the time slots can be provided in different colors to indicate different preferences, availabilities, priorities, rankings, deadlines, etc. For example, the preferred time slots can be colored green, the next preferred time slots can be colored yellow, and the least preferred time slots can be colored red. In some cases, the fuzzy template 300 can be provided as a list or a group of preferences, instead of a calendar with preferences, for example. Indeed, one of ordinary skill in the art will readily recognize after reading this disclosure that the preferences contained in the fuzzy template 300 can be provided by a user in many other formats. However, the preferences in the fuzzy template 300 are provided as markings in a calendar for illustration purposes.

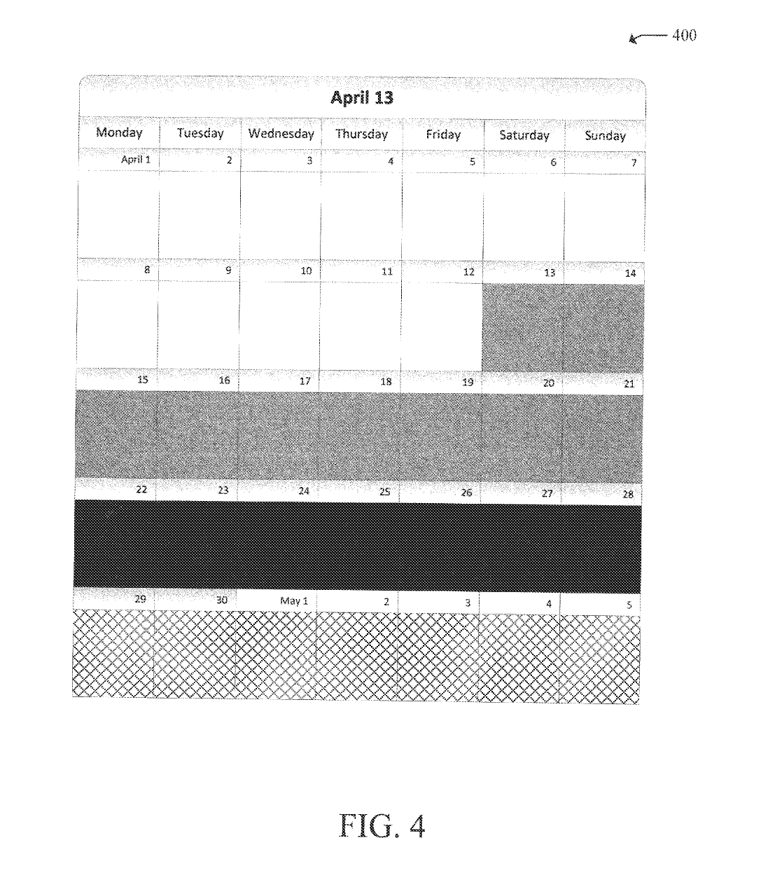

FIG. 4 illustrates an example fuzzy deadline 400 for an activity. The fuzzy deadline 400 can define a deadline spectrum for the activity. Here, the fuzzy deadline can specify a range of deadlines for completing the activity. The days with no shading in the fuzzy deadline 400 (April 1-April 12), can indicate a first deadline for completing the activity. The first deadline can be a soft or aspirational deadline. Thus, if the activity is not completed by the end of the first deadline, it can be extended to the next deadline. The next deadline, or the second deadline, is represented in the fuzzy deadline 400 by the days shaded in gray (April 13-April 21). The second deadline is also not a mandatory deadline. Therefore, the fuzzy planning system 200 can extend the activity to the next deadline if the activity is not completed by the end of the second deadline. Finally, the third deadline is represented in the fuzzy deadline 400 by the days shaded in black (April 22-April 28). The third deadline is a hard or mandatory deadline. Thus, the activity must be completed by the third deadline, as it cannot be extended past the third deadline. The days with the checkered pattern (April 29-May 5) are overdue days, or days after the mandatory deadline.

The fuzzy planning system 200 can use the fuzzy deadline 400 to determine a schedule for the user. In particular, the fuzzy planning system 200 can use the deadline information from the fuzzy deadline 400 to identify and/or assign priorities to different days and/or time slots for completing an activity. Thus, if an activity is near the third or mandatory deadline, the fuzzy planning system 200 can assign the activity a high priority and schedule the activity over other activities having a lower priority. On the other hand, if the activity is in the first deadline, the fuzzy planning system 200 can assign the activity a low priority. Thus, if necessary, the fuzzy planning system 200 can postpone the activity to schedule a higher priority activity.

While the fuzzy deadline 400 in FIG. 4 illustrates three levels of deadlines (i.e., the first deadline, the second deadline, and the third deadline), the present disclosure contemplates that the fuzzy deadline 400 can include more or less levels of deadlines. For example, in some embodiments, the fuzzy deadline 400 can include two alternative deadlines for an activity. Yet in other embodiments, the fuzzy deadline 400 can include four or more levels of deadlines. The three levels of deadlines in FIG. 4 are provided for illustration purposes.

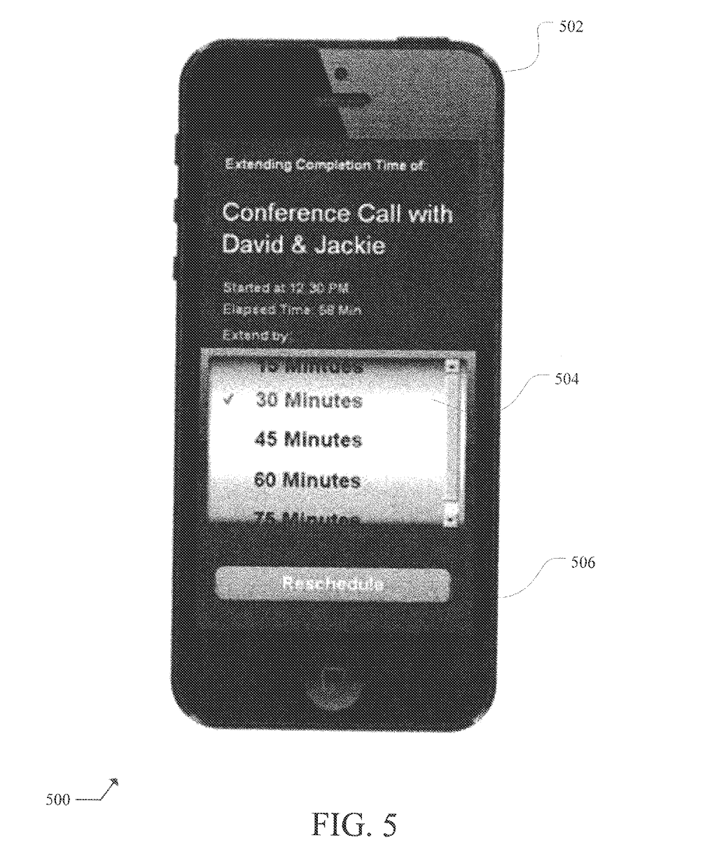

FIG. 5 illustrates an example system 500 for sending an update to a fuzzy planning system. The system 500 can include a device with networking capabilities, such as user terminal 102ᵢ illustrated in FIG. 1, for sending an update to the fuzzy planning system 200, in order to extend a scheduled activity. For example, if an activity runs over the allotted and/or expected time, the user can send an update to the fuzzy planning system 200, notifying the fuzzy planning system 200 that the activity must be extended because it ran passed the scheduled time. Here, the user can select an amount of time 504 for extending the activity. The user can then reschedule the activity by submitting a request to extend the activity via the reschedule button 506. In some embodiments, the user can select a time slot in a calendar to request for the activity to be extended to that time slot. The fuzzy planning system 200 can receive the request and update the activity accordingly. In other embodiments, the user can submit a request to extend the activity via a message, an email, a command, a voice command, a template, a form, a web page, an input button, etc.

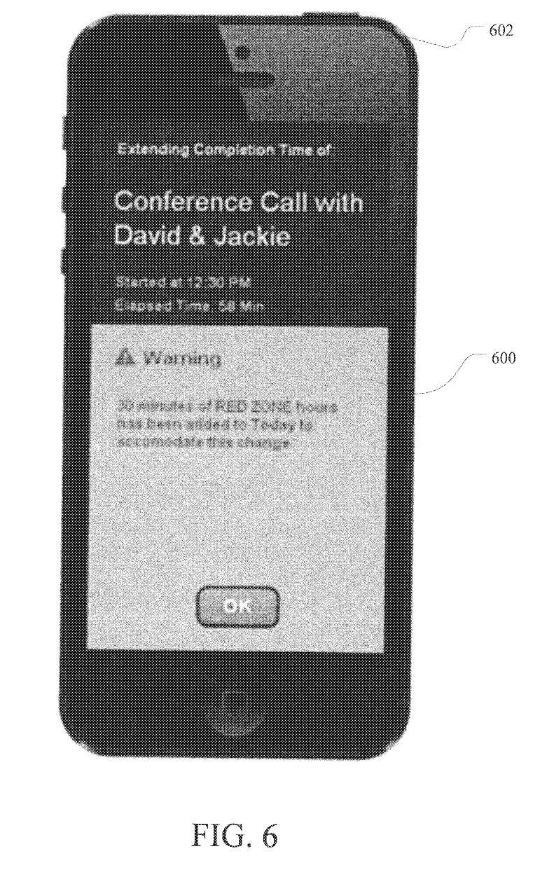

FIG. 6 illustrates an example warning 600 for extending an activity. The warning 600 can alert the user that the activity has been extended, as requested by the user. The warning 600 can also alert the user of any significant consequences of extending the activity. For example, the warning 600 can alert the user that the activity has been extended into a red zone of time, or a hard deadline, for example. In some embodiments, the warning 600 can also alert the user of any significant consequences affecting other activities. For example, the warning 600 can alert the user that a different activity has been extended into undesired time slots to accommodate the extension of the activity extended based on the user's prior request. The user can receive the warning 600 on the device 602, which can be, for example, a user terminal 102ᵢ, as illustrated in FIG. 1. In some embodiments, the user can receive a warning via text, email, pop-up message, calendar alert, voice alert, etc.

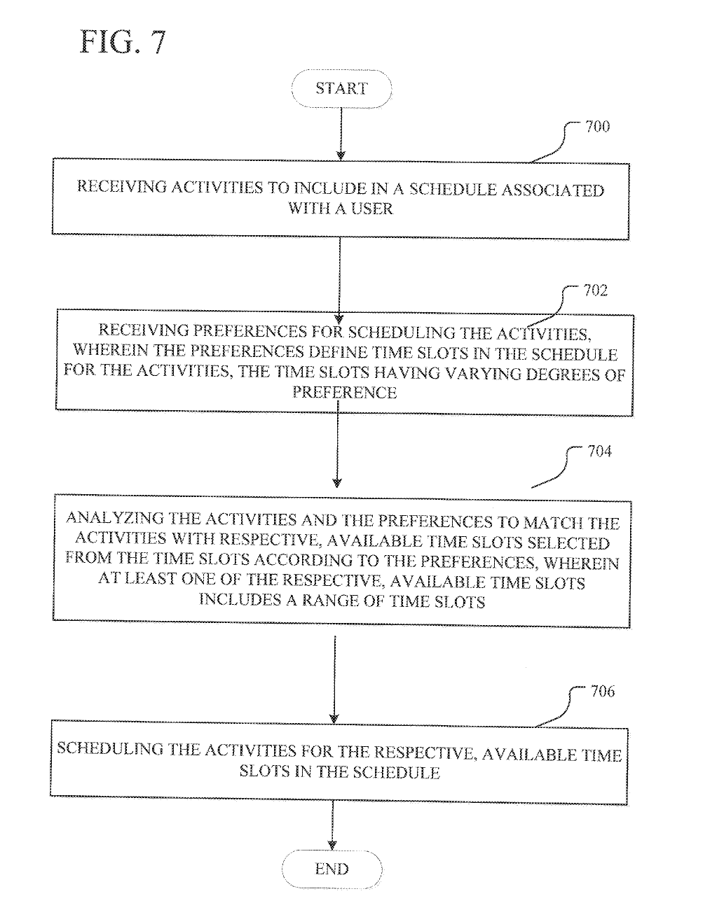

Having disclosed some basic system components and concepts, the disclosure now turns to the exemplary method embodiment shown in FIG. 7. For the sake of clarity, the method is described in terms of the cloud computing system 100, as shown in FIG. 1, configured to practice the method. The steps outlined herein are exemplary and can be implemented in any combination thereof, including combinations that exclude, add, or modify certain steps.

The system 100 first receives activities to include in a schedule associated with a user (700). The activities can include events, tasks, assignments, project phases, actions, and so forth. The system 100 also receives preferences for scheduling the activities, wherein the preferences define time slots in the schedule for the activities, the time slots having varying degrees of preference (702). The preferences can define the varying degrees of preference of the time slots. This way, the system 100 can determine from the preferences which time slots may be suitable and/or acceptable for each activity. For example, the preferences can define a range of time slots for scheduling an activity. Here, the time slots can include an ideal or preferred time slot for the activity, another time slot representing a second choice for the activity, and any additional time slots, which can represent any additional choices for scheduling the activity. This can provide the system 100 with multiple options and/or alternatives for scheduling the activity. In some cases, the time slots included in the range of time slots can be ranked and/or ordered. Moreover, the number of time slots defined in the preferences for the activities can vary by activity. For example, the preferences can define multiple time slots for some activities, but only a single time slot for other activities. In other words, the preferences can provide the system 100 with multiple options for scheduling some activities, and only one option for scheduling other activities. For example, some activities may have to be scheduled at a particular time for reasons that may be out of the user's control. Here, the preferences may only specify one option (e.g., the particular time) for scheduling these activities. On the other hand, some activities are more flexible, and may be scheduled at various times. Thus, the preferences can specify various options for scheduling such activities.

The preferences can also define priorities for the activities, durations for the activities, relationships between the activities, dependencies between the activities, deadlines for the activities, locations for the activities, requirements, prerequisites, etc. For example, the preferences can specify that some activities have a high priority, while other activities have a low priority. In some cases, the preferences can include more than one deadline for one or more activities. For example, the preferences can include a deadline spectrum for an activity. As another example, the preferences can define a soft deadline and a hard deadline for an activity. The soft deadline can indicate that the activity should be completed by the soft deadline, but may be completed at a later time if necessary. The hard deadline can indicate that the activity must be completed by the hard deadline, and the time allotted for the activity cannot be extended.

Next, the system 100 can analyze the activities and the preferences to match the activities with respective, available time slots selected from the time slots according to the preferences, wherein at least one of the respective, available time slots includes a range of time slots (704). The range of time slots can allow a scheduled time for an activity to be shifted to change the scheduled time. For example, an activity can be matched with a range of time slots, so the activity can be scheduled at any of the time slots in the range of time slots. Thus, if the activity is scheduled for a specific time slot in the range of time slots, and the system 100 subsequently determines that the activity has to be scheduled for a different time slot, the system 100 can then reschedule the activity for any other time slot from the range of time slots. Here, the system 100 can select an appropriate time slot from multiple time slots for scheduling the activity and avoiding, minimizing, prioritizing, and/or managing any conflicts.

The system 100 can then schedule activities for the respective, available time slots in the schedule (706). For each activity, the system 100 can avoid, minimize, and/or manage a conflict with other activities by scheduling the activity for the respective, available time slot, as the respective, available time slot can be selected by the system 100 for that purpose from the time slots having varying degrees of preference. Moreover, the scheduling process can be flexible, allowing the system 100 to choose a time slot for each activity from a number of different time slots that are available so that system 100 can accommodate each activity while avoiding, minimizing, and/or managing a conflict. The system 100 can also dynamically and automatically reschedule any of the activities to accommodate new activities and/or any change in circumstances. For example, the system 100 can schedule activity A for 9:00 a.m.-10:00 a.m., and activity B for 10:00 a.m.-11:30 a.m. If activity A runs 30 minutes late, and does not end until 10:30 a.m., the system 100 can dynamically and automatically reschedule activity B and/or any other future activities in the schedule that are affected by the fact that activity A ran 30 minutes late. Here, the system 100 can reschedule activity B to 10:30 a.m.-12:00 p.m., for example. This way, the system 100 can avoid or minimize any conflicts with activity A that may arise when activity A runs late. The system 100 can also determine if any activities scheduled after activity B would be affected by the rescheduling of activity B. If so, the system 100 can reschedule the affected activities in a similar way as the rescheduling of activity B.

The new time slot added to activity B, viz., 11:30 a.m.-12:00 p.m., can be selected by the system 100 from the additional time slots defined by the preferences for activity B. For instance, if the preferences specify that the preferred time slot for activity B is 10:00 a.m.-11:30 a.m., and the additional time slots for activity B are 9:30 a.m.-10:00 a.m. and 11:30 a.m.-1:00 p.m., then the system 100 can automatically reschedule activity B for any of the preferred and/or additional time slots, which provide the system 100 with a range of time slots for activity B from 9:30 a.m.-1:00 p.m., as necessary to avoid or minimize a conflict and/or accommodate a change in circumstances. In our example, the system 100 rescheduled activity B to start at 10:30 a.m., which is defined by the preferences as one of the preferred time slots for activity B, and end at 12:00 p.m., which is defined by the preferences as one of the additional time slots for activity B. Thus, the system 100 combined some of the preferred time slots for activity B with some of the additional time slots for activity B in order to accommodate a change of circumstances (i.e., activity A running 30 minutes late).

While FIG. 7 describes the scheduling of activities for a user, the present disclosure contemplates that the fuzzy planning concepts can also be applied for scheduling resources. For example, the fuzzy planning concepts can be implemented for scheduling a printer in a business, where a specific business department is assigned time slots for using the printer according to various fuzzy preferences. Here, the resource can have its own set of fuzzy preferences. For example, a meeting room can include a set of fuzzy preferences specifying priorities for different people and/or groups and indicating different availabilities. These fuzzy preferences can then be used to automatically generate, update, and/or manage a schedule for the meeting room. For example, a meeting room within the business department of a company may have fuzzy preferences providing a higher priority to employees in the business department than other employees. Thus, if there is a scheduling conflict between a human resources employee and a business department employee, the system can give the business department employee a higher priority than the human resources employee. If the fuzzy preferences for the conference room define various time slots for rescheduling the reservations from the human resources employee and/or the business department employee, the system can automatically make changes to the schedule to accommodate at least one of the reservations, giving priority to the business department employee.

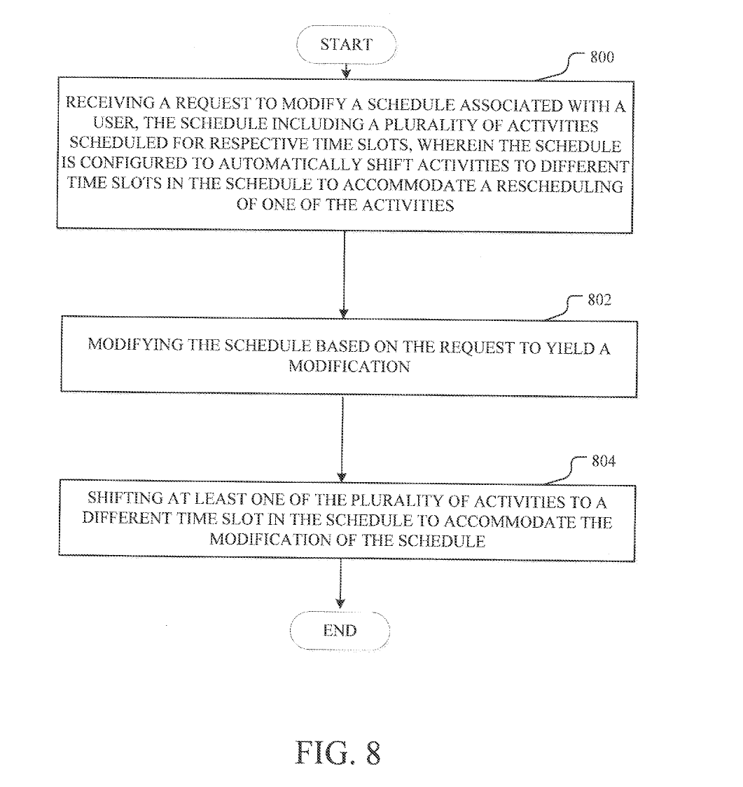

The disclosure now turns to the exemplary method embodiment shown in FIG. 8. For the sake of clarity, the method is described in terms of the user terminal 102ᵢ, as shown in FIG. 1, configured to practice the method. The steps outlined herein are exemplary and can be implemented in any combination thereof, including combinations that exclude, add, or modify certain steps.

The user terminal 102ᵢ first receives a request to modify a schedule associated with a user, the schedule including a plurality of activities scheduled for respective time slots, wherein the schedule is configured to automatically shift activities to different time slots in the schedule to accommodate a rescheduling of one of the activities (800). The request to modify the schedule can be triggered by a number of factors and/or events, such as an addition of a new activity, changes to an attribute of an existing activity (e.g., duration, preferences, temporal relations with other activities, start time, due date, priority, deadline information, prerequisites, status, etc.). The schedule can be configured to automatically shift activities to different time slots based on scheduling preferences associated with the user. The schedule can also be configured to automatically shift activities to different time slots based on a second schedule associated with a second user and scheduling preferences associated with the second user.

The scheduling preferences can define a range of time slots for at least one of the plurality of activities. The range of time slots can include time slots in the schedule having varying degrees of preference, for example. The scheduling preferences can also define relative priorities associated with the plurality of activities, relationships between the plurality of activities, dependencies between the plurality of activities, and/or deadlines associated with the plurality of activities. The deadlines can include one or more deadlines for a respective activity. For example, the deadlines can include a hard deadline and a soft deadline for an activity.

Next, the user terminal 102ᵢ can modify the schedule based on the request to yield a modification (802). The modification can include adding an activity to the schedule, removing an activity from the schedule, changing a recurring activity in the schedule, changing a scheduling preference, changing an attribute associated with an activity and/or a preference, moving an activity in the schedule to a different, respective time slot in the schedule, etc.

The user terminal 102ᵢ can then shift at least one of the plurality of activities to a different time slot in the schedule to accommodate the modification of the schedule (804). If the modification creates a time conflict between two or more activities, the user terminal 102ᵢ can shift one of the activities to the different time slot to resolve the time conflict.

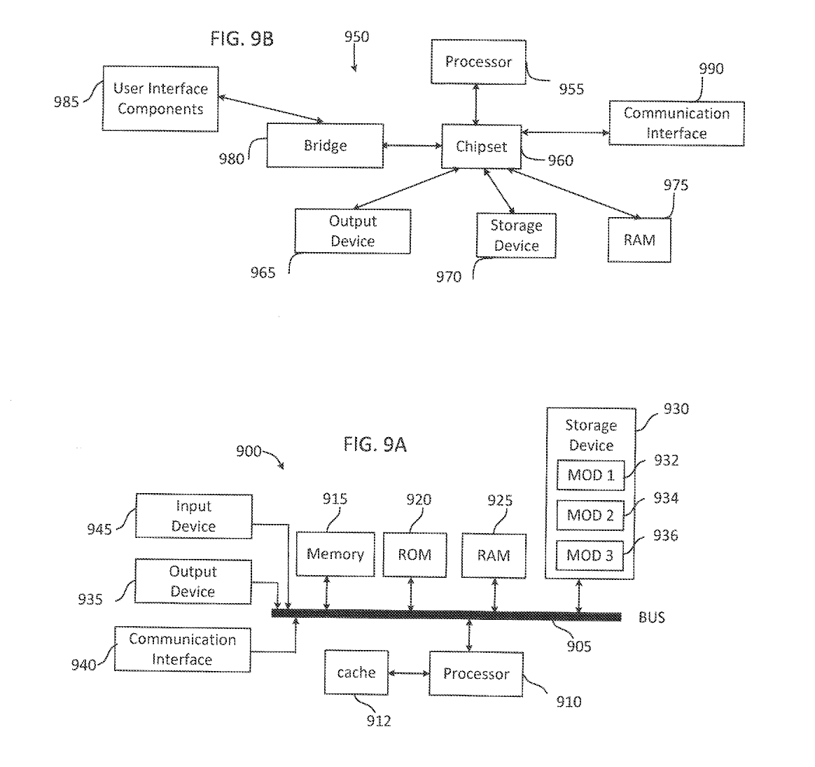

FIG. 9A, and FIG. 9B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 9A illustrates a conventional system bus computing system architecture 900 wherein the components of the system are in electrical communication with each other using a bus 905. Exemplary system 900 includes a processing unit (CPU or processor) 910 and a system bus 905 that couples various system components including the system memory 915, such as read only memory (ROM) 920 and random access memory (RAM) 925, to the processor 910. The system 900 can include a cache of high-speed memory connected directly with, in close proximity to, or integrated as part of the processor 910. The system 900 can copy data from the memory 915 and/or the storage device 930 to the cache 912 for quick access by the processor 910. In this way, the cache can provide a performance boost that avoids processor 910 delays while waiting for data. These and other modules can control or be configured to control the processor 910 to perform various actions. Other system memory 915 may be available for use as well. The memory 915 can include multiple different types of memory with different performance characteristics. The processor 910 can include any general purpose processor and a hardware module or software module, such as module 1 932, module 2 934, and module 3 936 stored in storage device 930, configured to control the processor 910 as well as a special-purpose processor where software instructions are incorporated into the actual processor design. The processor 910 may essentially be a completely self-contained computing system, containing multiple cores or processors, a bus, memory controller, cache, etc. A multi-core processor may be symmetric or asymmetric.

To enable user interaction with the computing device 900, an input device 945 can represent any number of input mechanisms, such as a microphone for speech, a touch-sensitive screen for gesture or graphical input, keyboard, mouse, motion input, speech and so forth. An output device 935 can also be one or more of a number of output mechanisms known to those of skill in the art. In some instances, multimodal systems can enable a user to provide multiple types of input to communicate with the computing device 900. The communications interface 940 can generally govern and manage the user input and system output. There is no restriction on operating on any particular hardware arrangement and therefore the basic features here may easily be substituted for improved hardware or firmware arrangements as they are developed.

Storage device 930 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 925, read only memory (ROM) 920, and hybrids thereof.

The storage device 930 can include software modules 932, 934, 936 for controlling the processor 910. Other hardware or software modules are contemplated. The storage device 930 can be connected to the system bus 905. In one aspect, a hardware module that performs a particular function can include the software component stored in a computer-readable medium in connection with the necessary hardware components, such as the processor 910, bus 905, display 935, and so forth, to carry out the function.

FIG. 9B illustrates a computer system 950 having a chipset architecture that can be used in executing the described method and generating and displaying a graphical user interface (GUI). Computer system 950 is an example of computer hardware, software, and firmware that can be used to implement the disclosed technology. System 950 can include a processor 955, representative of any number of physically and/or logically distinct resources capable of executing software, firmware, and hardware configured to perform identified computations. Processor 955 can communicate with a chipset 960 that can control input to and output from processor 955. In this example, chipset 960 outputs information to output 965, such as a display, and can read and write information to storage device 970, which can include magnetic media, and solid state media, for example. Chipset 960 can also read data from and write data to RAM 975. A bridge 980 for interfacing with a variety of user interface components 985 can be provided for interfacing with chipset 960. Such user interface components 985 can include a keyboard, a microphone, touch detection and processing circuitry, a pointing device, such as a mouse, and so on. In general, inputs to system 950 can come from any of a variety of sources, machine generated and/or human generated.

Chipset 960 can also interface with one or more communication interfaces 990 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 955 analyzing data stored in storage 970 or 975. Further, the machine can receive inputs from a user via user interface components 985 and execute appropriate functions, such as browsing functions by interpreting these inputs using processor 955.

It can be appreciated that exemplary systems 900 and 950 can have more than one processor 910 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Claim language reciting “at least one of” a set indicates that one member of the set or multiple members of the set satisfy the claim.

What is claimed is:

1. A method comprising:
providing a scheduling application at a device associated with a user;
obtaining, based on user preferences, a plurality of fuzzy templates for different activities to be scheduled on the scheduling application, wherein each of the plurality of fuzzy templates corresponds to a respective activity from the different activities, and wherein each of the plurality of fuzzy templates comprises a first time slot for scheduling the respective activity and one or more second time slots for scheduling the respective activity, the user preferences defining varying degrees of preference for the first time slot and the one or more second time slots;
scheduling, via a processor, the different activities on the scheduling application based on the plurality of fuzzy templates to yield a schedule; and
presenting the schedule via the scheduling application.

2. The method of claim 1, wherein the user preferences define a first degree of preference for the first time slot and one or more second degrees of preference for the one or more second time slots, wherein the first degree of preference is higher than the one or more second degrees of preference.

3. The method of claim 2, wherein the one or more second degrees of preference comprise a second degree of preference for a second time slot and one or more third degrees of preference for one or more additional time slots, wherein the second degree of preference is higher than the one or more third degrees of preference.

4. The method of claim 1, further comprising identifying a conflict between at least two of the different activities, and dynamically re-mapping the at least two of the different activities for non-conflicting, available time slots on the schedule based on the user preferences.

5. The method of claim 1, further comprising:
detecting that an activity mapped to a respective first time slot needs additional time to complete;
detecting a conflict between a respective second time slot associated with the activity and at least one of a first time slot or a second time slot of a second activity; and
dynamically mapping the activity to a respective third time slot in the schedule, the respective third time slot being defined by a respective fuzzy template associated with the activity, wherein the respective first time slot is associated with a higher preference in the user preferences than the respective second time slot and the respective second time slot is associated with a higher preference in the user preferences than the respective third time slot.

6. The method of claim 1, the user preferences defining, for at least one of the different activities, a first acceptable start time, a first acceptable stop time, a second acceptable start time, and a second acceptable stop time, and wherein the at least one of the different activities is mapped to one or more respective time slots selected based on the first acceptable start time, the first acceptable stop time, the second acceptable start time, and the second acceptable stop time, wherein the first acceptable start time and the first acceptable stop time are associated with a higher preference than a respective preference of the second acceptable start time and the second acceptable stop time, wherein the first acceptable start time and the first acceptable stop time are color coded in the schedule according to a first color to indicate the higher preference, and wherein the second acceptable start time and the second acceptable stop time are color coded in the schedule according to a second color to indicate the respective preference of the second acceptable start time and the second acceptable stop time.

7. The method of claim 6, wherein the user preferences also define a first acceptable deadline and a second acceptable deadline for the at least one of the different activities, wherein the first acceptable deadline comprises a preferred deadline and the second acceptable deadline comprises a hard deadline, and wherein the one or more respective time slots are also selected based on the first acceptable deadline and the second acceptable deadline.

8. The method of claim 7, wherein an activity scheduled for a respective time slot according to the first acceptable deadline is rescheduled for a different, respective time slot according to the second acceptable deadline in response to a scheduling change request, wherein the scheduling change request comprises a request to schedule another activity for the respective time slot, wherein the other activity has a higher priority than the activity.

9. The method of claim 1, wherein at least two of the plurality of fuzzy templates are associated with a same slot of time.

10. The method of claim 1, wherein the schedule is configured to automatically shift at least one of the different activities to a different time slot from the first time slot and one or more second time slots in order to accommodate a scheduling needed for one or more other activities.

11. The method of claim 1, wherein the user is a first user and the different activities comprise a meeting with a second user, the method further comprising:
receiving a second set of user preferences associated with the second user, the second set of user preferences defining time slots corresponding to a second schedule associated with the second user and respective degrees of preference for the time slots;
identifying a time slot for the meeting in both the schedule associated with the first user and the second schedule associated with the second user, wherein the time slot is selected from a range of time slots to avoid conflicts with activities scheduled in the schedule associated with the first user and the second schedule associated with the second user, the range of time slots being associated with respective degrees of preference in the user preferences and the second set of user preferences, and wherein the time slot is defined by both the user preferences associated with the first user and the second set of user preferences as being an option for the meeting; and
scheduling the matching activity for the time slot in the schedule associated with the first user.

12. The method of claim 1, wherein at least one of the different activities comprises a recurring activity, the method further comprising:
identifying a time conflict between an activity from the different activities and an occurrence in the recurring activity;
selecting, for the occurrence, a different time slot in the schedule to avoid the time conflict, wherein the different time slot is selected from a range of time slots associated with the recurring activity based on respective degrees of preference for each of the range of time slots as defined in the user preferences; and
scheduling the occurrence for the different time slot in the schedule.

13. The method of claim 1, wherein the preferences also define at least one of relationships between the different activities, durations of the different activities, dependencies between the different activities, or deadlines associated with the different activities, and wherein the deadlines comprise at least one of a hard deadline and a soft deadline.

14. A computer-readable storage device having stored therein instructions which, when executed by a processor, cause the processor to perform operations comprising:
providing a scheduling application at a device associated with a user;
obtaining, based on user preferences, a plurality of fuzzy templates for different activities to be scheduled on the scheduling application, wherein each of the plurality of fuzzy templates corresponds to a respective activity from the different activities, and wherein each of the plurality of fuzzy templates comprises a first time slot for scheduling the respective activity and one or more second time slots for scheduling the respective activity, the user preferences defining a first degree of preference for the first time slot and one or more second degrees of preference for the one or more second time slots, the first degree of preference comprising a higher preference than the one or more second degrees of preference;
scheduling the different activities on the scheduling application based on the plurality of fuzzy templates to yield a schedule; and
presenting the schedule via the scheduling application.

15. The computer-readable storage device of claim 14, wherein the first time slot comprises one or more slots of time associated with the scheduling application, and wherein the one or more second time slots comprise one or more slots of time associated with the scheduling application.

16. The computer-readable storage device of claim 14, wherein at least two of the plurality of fuzzy templates are associated with a same slot of time.

17. The computer-readable storage device of claim 14, wherein at least one of the different activities comprises a recurring activity, the computer-readable storage device storing additional instructions which, when executed by the processor, cause the processor to perform operations further comprising:
identifying a time conflict between an activity from the different activities and an occurrence in the recurring activity;
selecting, for the occurrence, a different time slot in the schedule to avoid the time conflict, wherein the different time slot is selected from a range of time slots associated with the recurring activity based on respective degrees of preference for each of the range of time slots as defined in the user preferences; and
scheduling the occurrence for the different time slot in the schedule.

18. The computer-readable storage device of claim 14, the preferences defining, for at least one of the different types of activities, a first acceptable start time, a first acceptable stop time, a second acceptable start time, and a second acceptable stop time, and wherein the at least one of the different types of activities is mapped to one or more respective time slots selected based on the first acceptable start time, the first acceptable stop time, the second acceptable start time, and the second acceptable stop time, wherein the first acceptable start time and the first acceptable stop time are associated with a higher preference than a respective preference of the second acceptable start time and the second acceptable stop time.

19. The computer-readable storage device of claim 14, wherein the user is a first user and the different activities comprise a meeting with a second user, the computer-readable storage device storing additional instructions which, when executed by the processor, cause the processor to perform operations further comprising:
receiving a second set of user preferences associated with the second user, the second set of user preferences defining time slots corresponding to a second schedule associated with the second user and respective degrees of preference for the time slots;
identifying a time slot for the meeting in both the schedule associated with the first user and the second schedule associated with the second user, wherein the time slot is selected from a range of time slots to avoid conflicts with activities scheduled in the schedule associated with the first user and the second schedule associated with the second user, the range of time slots being associated with respective degrees of preference in the user preferences and the second set of user preferences, and wherein the time slot is defined by both the user preferences associated with the first user and the second set of user preferences as being an option for the meeting; and
scheduling the matching activity for the time slot in the schedule associated with the first user.

20. A system comprising:
a processor; and
a computer-readable storage medium having stored therein instructions which, when executed by the processor, cause the processor to perform operations comprising:
providing a scheduling application at a device associated with a user;
receiving, based on user preferences, a plurality of fuzzy templates for different activities to be scheduled on the scheduling application, wherein each of the plurality of fuzzy templates corresponds to a respective activity from the different activities, and wherein each of the plurality of fuzzy templates comprises a first time slot for scheduling the respective activity and one or more second time slots for scheduling the respective activity, the user preferences defining varying degrees of preference for the first time slot and the one or more second time slots;
scheduling the different activities on the scheduling application based on the plurality of fuzzy templates to yield a schedule; and
presenting the schedule via the scheduling application.
